(19) United States
(12) Patent Application Publication
(10) Pub. No.: US 2012/0215864 A1
(43) Pub. Date: Aug. 23, 2012

(54) DOCUMENT MANAGEMENT APPARATUS AND METHOD OF CONTROLLING THE SAME

(75) Inventor: Fumihiro Fukuoka, Yokohama-shi (JP)

(73) Assignee: CANON KABUSHIKI KAISHA, Tokyo (JP)

(21) Appl. No.: 13/399,968

(22) Filed: Feb. 17, 2012

(30) Foreign Application Priority Data
Feb. 22, 2011 (JP) 2011-036023

(51) Int. Cl. G06F 15/16

(52) U.S. Cl. 709/206

(57) ABSTRACT

A document management apparatus according to the present invention performs storing, in response to a document registration request from an information processing apparatus, a document entity of the document, acquiring document information of the document, and storing data of a type determined based on the acquired document information, as a preview-image document of the document, and determining, upon reception of an acquisition request for the preview-image document from the information processing apparatus, whether the preview-image document stored in the preview-image document storage unit or the document entity stored in the document entity storage unit is to be transmitted based on a state of the document management apparatus, and transmitting data determined to be transmitted.

### BACKGROUND OF THE INVENTION

1. Field of the Invention

The present invention relates to a technique for managing electronic documents and images to simply display electronic documents (thumbnail preview images).

2. Description of the Related Art

In recent years, an increasing number of document management systems including world wide web (WWW)-based applications has been used. Generally in such a document management system, a personal computer (hereinafter referred to as PC) handles electronic documents (hereinafter referred to as documents) by using a dedicated client application and a WWW browser (hereinafter referred to as browser). The document management system manages folders and documents in a hierarchical structure, and shares documents by giving each user a different right to access folders and documents.

To manage documents arranged in any folder, the above-described client application (hereinafter referred to as application) is provided with functions of displaying a document list, displaying document attributes, and editing a document. To enable a user to check the contents of documents, the application is also capable of generating and displaying thumbnail images of starting pages and preview images of all pages of documents.

However, there has been a problem that, when the application acquires document entity data from a document management server and generates thumbnail images and preview images on a client PC, both the client PC and the document management server are loaded particularly with a large size of the document entity data.

Japanese Patent Application Laid-Open No. 2000-268164 discusses a technique with which a server generates in advance low-resolution images (thumbnail images and preview images) based on documents, and returns images having a required size in response to a request from a client PC.

Although the technique discussed in Japanese Patent Application Laid-Open No. 2000-268164 can reduce the load occurring at the preview time, it is necessary to generate a plurality of images when registering a document. This burdens the document management system side (server side) particularly when a number of pages of the document is very large. Further, the technique cannot respond to a demand for browsing high-resolution images at the preview time.

### SUMMARY OF THE INVENTION

The present invention is directed to flexibly handling preview images for checking the contents of documents, depending on a server status.

According to an aspect of the present invention, a document management apparatus connectable with an information processing apparatus configured to transmit a document registration request and an acquisition request for a document includes a document entity storage unit configured to, in response to a document registration request from the information processing apparatus, store a document entity of the document, an acquisition unit configured to acquire document information of the document, a preview-image document storage unit configured to store data of a type determined based on the document information acquired by the acquisition unit, as a preview-image document of the document, and a transmission unit configured to, upon reception of an acquisition request for the preview-image document from the information processing apparatus, determine whether the preview-image document stored in the preview-image document storage unit or the document entity stored in the document entity storage unit is to be transmitted based on a state of the document management apparatus, and transmit data determined to be transmitted.

According to the present invention, it becomes possible to flexibly handle preview images for checking the contents of documents, depending on a server status.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates an example configuration of a document management system according to an exemplary embodiment of the present invention.

FIG. 2 illustrates an example internal configuration of an information processing apparatus included in the document management system according to an exemplary embodiment of the present invention.

FIG. 3 is a block diagram schematically illustrating an example functional configuration of a document management server and a client computer according to an exemplary embodiment of the present invention.

FIG. 4 illustrates an example main screen of an application for operating data on the document management system according to an exemplary embodiment of the present invention.

FIG. 5 illustrates an example of preview-image document type information table in the document management system according to an exemplary embodiment of the present invention.

FIG. 6A illustrates example data items for the document information table in the document management system according to an exemplary embodiment of the present invention.

FIG. 6B illustrates example data items for a preview-image document information table in the document management system according to an exemplary embodiment of the present invention.

FIG. 7 illustrates an example configuration of a structured document according to an exemplary embodiment of the present invention.

FIG. 8 is a flowchart illustrating example processing performed by the document management server according to an exemplary embodiment of the present invention upon reception of a document registration request.

FIG. 9 is a flowchart illustrating example processing performed by the document management server according to an exemplary embodiment of the present invention upon reception of an acquisition request for a preview-image document (hereinafter referred to as preview-image document acquisition request).

FIG. 10 is a flowchart illustrating example processing performed by the client computer according to an exemplary embodiment of the present invention to transmit a preview-image document acquisition request.

### DESCRIPTION OF THE EMBODIMENTS

Various exemplary embodiments, features, and aspects of the invention will be described in detail below with reference to the drawings.

The preferable mode for carrying out the present invention will be described below with reference to the accompanying drawings. In the present invention, a “document” refers to a unit for managing one or more files, and is defined as an object for managing information accompanying one or more files.

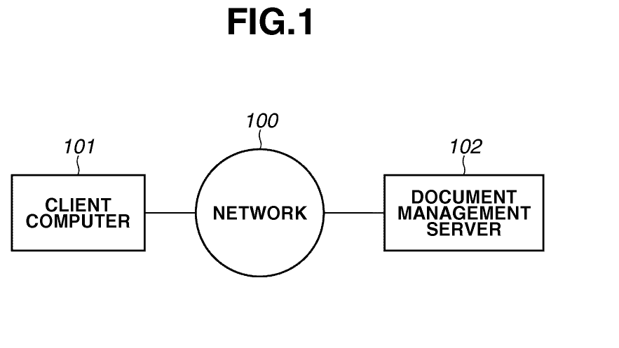

FIG. 1 illustrates an example configuration of a document management system. As illustrated in FIG. 1, the document management system according to a first exemplary embodiment of the present invention includes a client computer 101 as an information processing apparatus, and a document management server 102 as a document management apparatus. The client computer 101 and the document management server 102 are mutually connectable via a network 100 such as the Internet and a local area network (LAN).

The client computer 101 is computer equipment such as a personal computer used by a user. In the following descriptions, the client computer 101 is referred to as PC 101 as required.

The PC 101 is provided with a preinstalled client application for browsing and editing folders and document information acquired by accessing the document management server 102. The PC 101 is further provided with a preinstalled document management application for referencing, editing, and managing the contents of documents registered in the document management server 102 and documents stored in the PC 101. By using the document management application, the PC 101 transmits to the document management server 102 processing execution requests such as a document registration request and an acquisition request for a document (hereinafter referred to as document acquisition request). Thus, the PC 101 performs processing for browsing, updating, and deleting folders and document information on the document management server 102.

Although, in the present exemplary embodiment, an example case where the PC 101 accesses the document management server 102 by using the document management application will be described, the document management application is not necessarily used. For example, the PC may access the document management server 102 by using a web browser and browser's extended functions.

The document management server 102 is a system including one or a plurality of information processing apparatuses. The one or plurality of information processing apparatuses is used to store and manage “information resources such as folders and documents” generated and registered by the user.

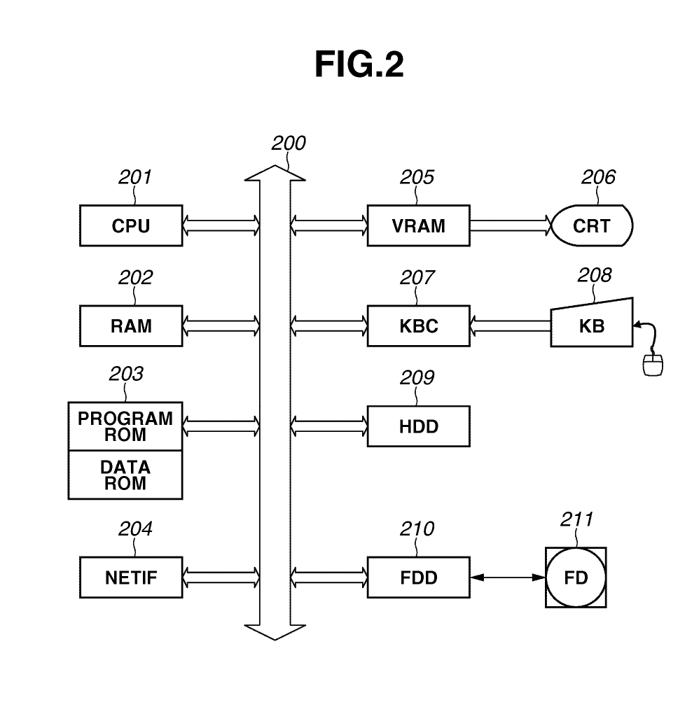

FIG. 2 illustrates an example internal configuration of the information processing apparatus applied to the PC 101 and the document management server 102. A central processing unit (CPU) 201 controls operations of the information processing apparatus. A random access memory (RAM) 202 functions as a main memory for the CPU 201. The RAM 202 also functions as a storage area for an implementation program, an execution area for the implementation program, and a data area for the implementation program.

A read-only memory (ROM) 203 stores operating procedures of the CPU 201. The ROM 203 includes a program ROM storing an operating system (OS) which is a system program for controlling devices in the information processing apparatus, and a data ROM storing information required to operate the document management system. A hard disk drive (HDD) 209 (described below) may be used instead of the ROM 203.

A network interface (NETIF) 204 controls data transmission to/from external apparatuses via the network 100, and diagnoses a status of the information processing apparatus concerning its connection to the network 100. A video RAM (VRAM) 205 rasterizes an image to be displayed on the screen of a cathode ray tube (CRT) 206 (described below) and controls display of the image.

The display unit (CRT) 206 displays an operating status of the information processing apparatus. A keyboard controller (KBC) 207 controls an input signal from a keyboard (KB) 208 (described below). The external input unit (KB) 208 receives an operation performed by the user. The KB 208 is, for example, a pointing device such as a keyboard and a mouse.

The HDD 209 stores application programs and various types of data. Application programs in the present exemplary embodiment are pieces of software configured to execute various processing units in the present exemplary embodiment.

An external I/O apparatus (flexible disk drive (FDD)) 210 outputs and inputs data to/from a magnetic recording medium such as a flexible disk, an optical recording medium such as a compact disc read-only memory (CD-ROM), a magneto-optical recording medium such as a magneto-optical (MO) disk, and a semiconductor recording medium such as a memory card. For example, the external I/O apparatus (FDD) 210 is used to read the above-described application program from a recording medium.

A removable medium (flexible disk (FD)) 211 is a removable medium recording the data read by the FDD 210. The removable medium (FD) 211 is, for example, a magnetic recording medium (such as a flexible disk), an optical recording medium (such as a CD-ROM), a magneto-optical recording medium (such as a MO disk), and a semiconductor recording medium (such as a memory card).

An application program and data to be stored in the HDD 209 can be read from the FD 211 and used via the FDD 210.

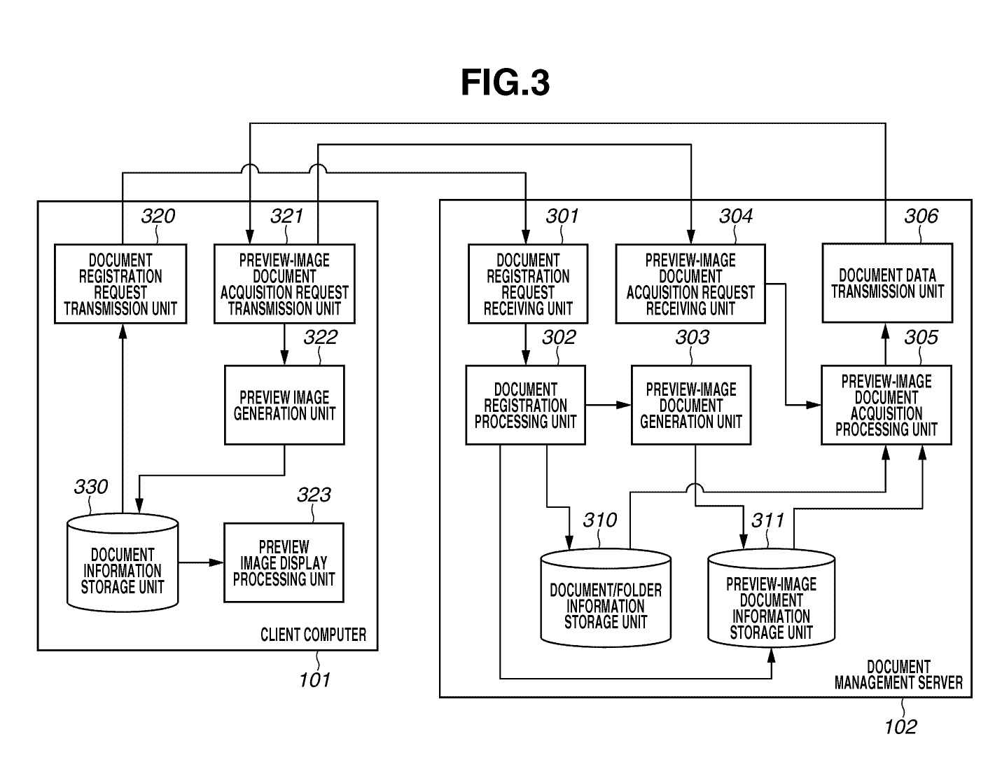

FIG. 3 is a block diagram schematically illustrating an example functional configuration of the PC 101 and the document management server 102. Each of the PC 101 and the document management server 102 has function units illustrated in FIG. 3. A plurality of document management servers 102 may be configured to achieve respective function units illustrated in FIG. 3.

The document management server 102 includes a plurality of processing units and a plurality of information storage units. The document management server 102 can manage cabinets, folders, and documents in the hierarchical structure, however, detailed descriptions of this structure will be omitted. In the present exemplary embodiment, any cabinets, folders, documents, and user information for accessing these pieces of information are preregistered in the document management server 102.

Processing units 301 to 306 execute processing in response to a request from the PC 101. The processing units 301 to 306 write and read data to/from information storage units 310 to 311.

Processing units 320 to 323 perform processing in response to a user operation and an operation of the document management application. A preview-image document acquisition request transmission unit 321 transmits a request to the document management server 102 and, upon reception of a response, leaves processing to the preview image generation unit 322. The document registration request transmission unit 320 reads information from the document information storage unit 330, and the preview image generation unit 322 writes in the information.

The document registration request transmission unit 320 and the preview-image document acquisition request transmission unit 321 may be configured as a part of the document management application program, or a program independent of the document management application.

Although descriptions of basic processing units and storage units of the document management application will be omitted, these units are configured on the premise that processing for transmitting a preview-image document acquisition request and processing for acquiring it can be performed in parallel.

It is premised that the document management application prestores destination information (identifier and authentication information of the document management server 102) required to transmit a request to the document management server 102. It is also premised that the storage units of the document management server 102 prestore information (user information, folder hierarchies, and documents) required for the document management server 102. Processing for storing these pieces of information is not directly related to the present invention, and descriptions will be omitted.

Programs for the processing units in FIG. 3 are prestored in the HDD 209, loaded into the RAM 202, and executed by the CPU 201. The programs for the processing units in FIG. 3 rasterize into the RAM 202 the data read from respective storage units of the HDD 209, write a result of processing executed by the CPU 201 to respective storage units of the HDD 209, and leave processing to other processing units. Functions of the processing units and the information storage units in FIG. 3 will be described below with reference to flowcharts.

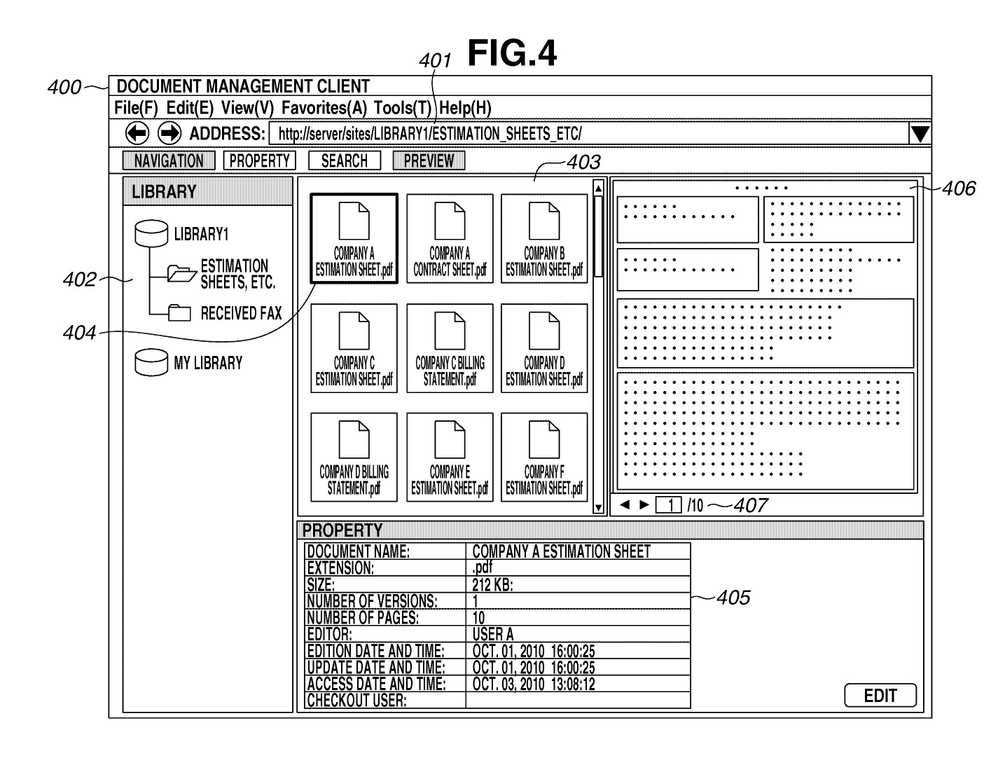

FIG. 4 illustrates an example of a main screen 400 of the document management application of the client computer 101 according to the present exemplary embodiment. The main screen 400 displays folders and document information stored in the document management server 102, and enables the user to edit a document.

A URL display area 401 is used to input and display an identifier for accessing the document management server 102. As the identifier, the user inputs a character string composed of a protocol to be used, the identifier of the document management server 102, and a path name to be used ranging from a target cabinet to a destination folder. When the user has input the character string, information about the specified folder appears.

A tree view area 402 displays the hierarchical structure of cabinets and folders stored in the document management server 102 in tree format.

A subfolder and document list display area 403 displays subfolders and documents existing under any folder selected in the tree view area 402. Although documents are displayed in the thumbnail display format in FIG. 4, they may be displayed in other display formats such as list format and icon format. To operate any folder or document, the user selects a target folder or document out of folders and documents displayed in the subfolder and document list display area 403, and then performs a menu, link, or button operation on the main screen 400. Referring to FIG. 4, a document 404 is selected.

A property information display area 405 displays attribute information of a folder or document selected in the subfolder and document list display area 403. A preview image display area 406 displays a preview image of the document selected in the subfolder and document list display area 403.

When there is a plurality of preview pages, a page operation area 407 displays the total number of pages and the current page number. The page operation area 407 includes operation buttons for shifting to the previous and following page, and a page number input box for jumping to a target page.

When the user performs any operation for a folder or document in the main screen 400, the client computer 101 transmits a relevant processing request to the document management server 102. The document management server 102 returns to the client computer 101 relevant data in response to the processing request. The client computer 101 receives the returned data and displays it on the main screen 400.

In the present exemplary embodiment, when the user selects any document displayed in the subfolder and document list display area 403, the document management application transmits to the document management server 102 a document attribute information acquisition request and a preview-image document acquisition request.

The document management server 102 returns attribute information and a preview-image document entity of the selected document to the document management application. The document management application displays the received document attribute information in the property information display area 405, and generates a preview image based on the received preview-image document entity, and displays the preview image in the preview image display area 406.

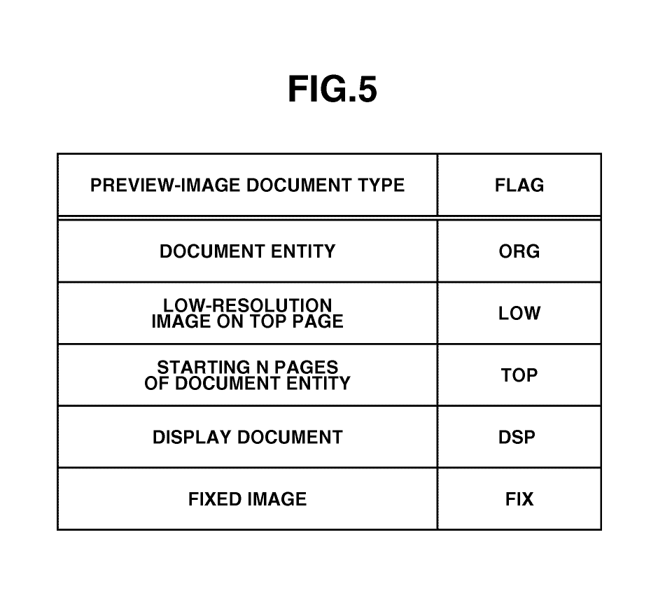

FIG. 5 illustrates example data items for document type information of the above-described preview-image document entity in the document management server 102. When the document management server 102 performs document registration processing, it stores a document type identification flag in the attribute information of the preview-image document to enable identifying a document format to be used for the preview-image document. When returning a preview-image document entity to the document management application, the document management server 102 also returns the above-described document type identification flag together. Since the attribute information is essential information required for the present exemplary embodiment, different data configurations may be used to achieve the present exemplary embodiment.

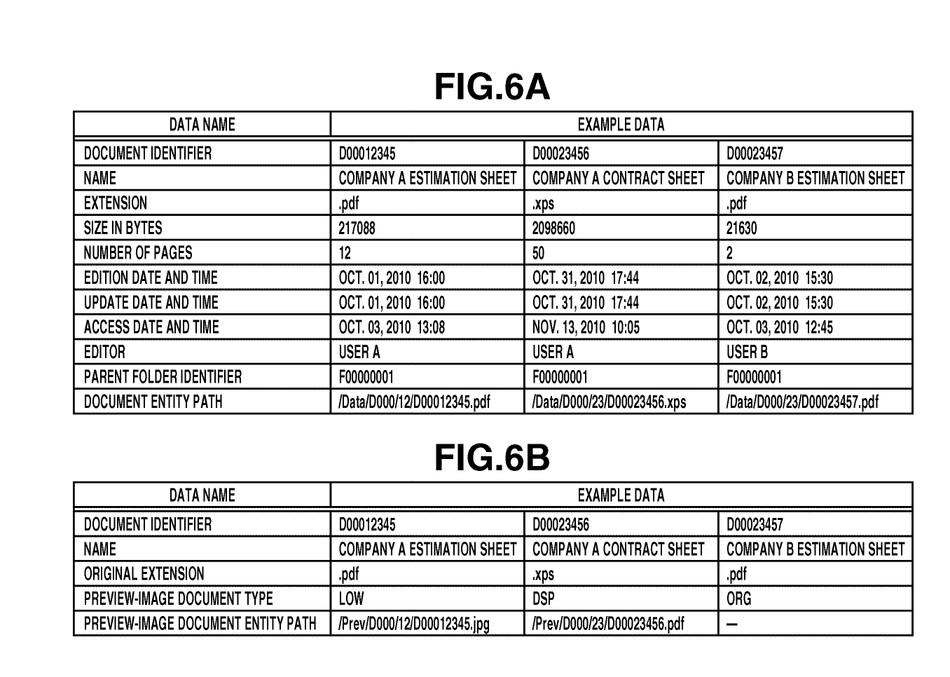

FIG. 6A illustrates example data items for the document information in the document management server 102. FIG. 6B illustrates example data items for preview-image document information in the document management server 102.

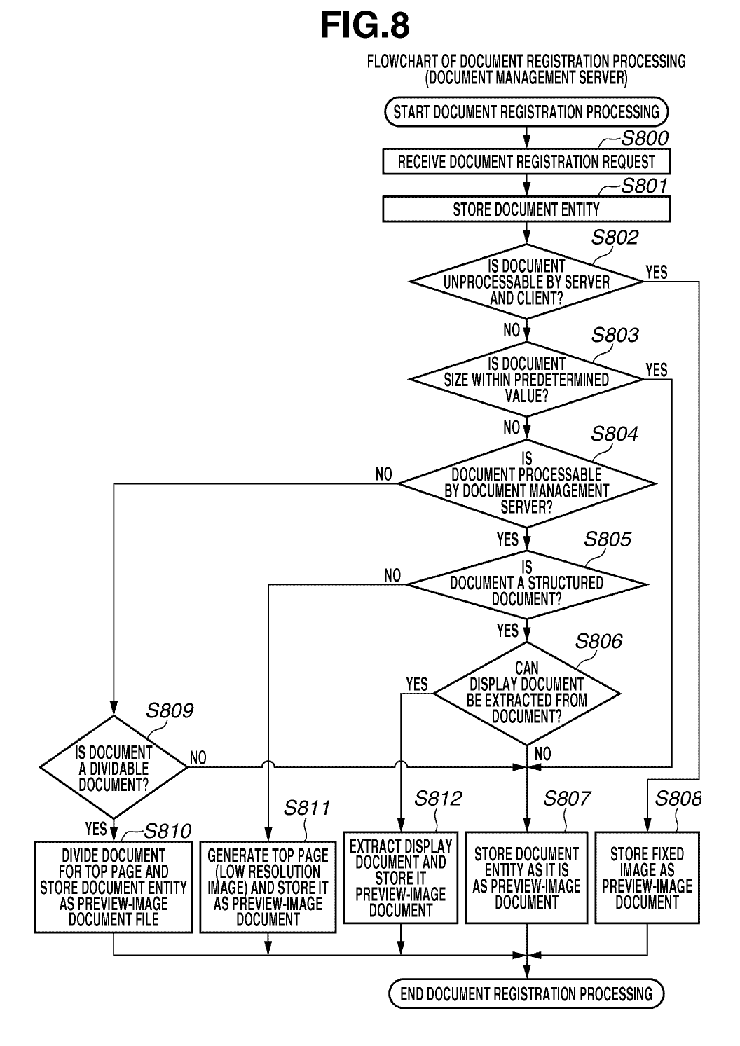

Data items in FIGS. 6A and 6B are associated with each other by a document identifier. The data type illustrated in FIG. 5 is stored as the preview-image document type in FIG. 6B. At the time of document registration processing, different preview-image document types are used depending on the attribute and state of the document entity. The document registration processing will be described below with reference to the flowchart in FIG. 8.

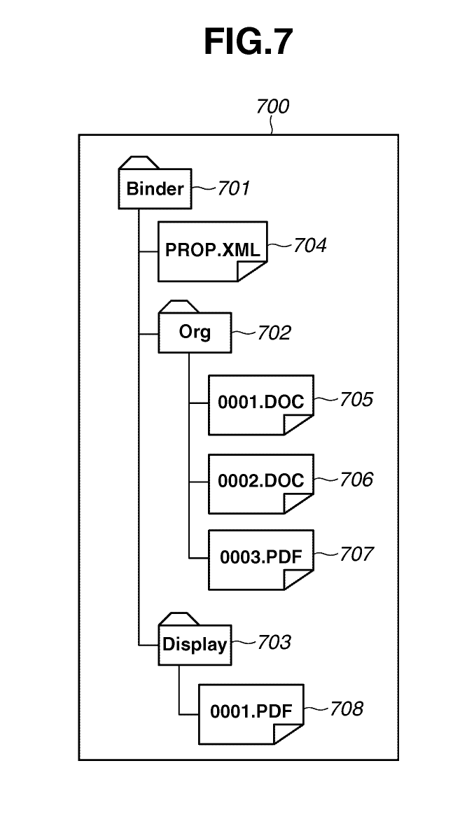

In the descriptions on the present exemplary embodiment, documents stored in the document management server 102 are classified into two types: a single document and a structured document composed of a plurality of documents. FIG. 7 illustrates an example configuration of a structured document.

A structured document, for example, an electronic binder document (hereinafter referred to as binder document) is composed of a plurality of documents, print settings, a document used for display, and a document describing the entire document configuration. Since the folder configuration is archived as it is with these structured documents arranged in respective subfolders, these documents can be handled as one document.

Referring to FIG. 7, a binder document 700 is composed of an attribute document 704, a subfolder 702 storing original documents 705 to 707, and a subfolder 703 storing a display document 708, all of which exist under a root folder 701.

In the present exemplary embodiment, the display document 708 is a portable document format (PDF) document. However the format is not limited thereto, and may be other formats. Further, the folder configuration in FIG. 7 is not limited thereto, and may be other configurations.

Processing from the time when the document management server 102 according to the present exemplary embodiment receives a document registration request (transmitted from the document registration request transmission unit 320 of the PC 101) until the time when it completes the document registration processing will be described below with reference to a flowchart in FIG. 8.

A program for the document management server 102 related to this flowchart and data required to execute the program are prestored in the HDD 209 of the document management server 102, and loaded into the RAM 202. The program is executed by the CPU 201. A temporary area of the RAM 202 or HDD 209 is used for data transfer between steps.

When the user performs an operation for storing any document in any folder of the tree view area 402 of the document management application on the PC 101, the document management application on the PC 101 transmits a document registration request to the document management server 102. Although there are different methods for transmitting a document registration request to the document management server 102 without using the document management application on the PC 101, they are not directly related to the present invention, and descriptions will be omitted.

In step S800, a document registration request receiving unit 301 of the document management server 102 receives a document registration request from the PC 101. Then, the document registration request receiving unit 301 acquires document information and a document entity from data received together with the document registration request, and leaves processing to the document registration processing unit 302.

In step S801, the document registration processing unit 302 stores the received document information and document entity in a document/folder information storage unit 310 of the HDD 209 (document entity storage processing). In step S802, the document registration processing unit 302 determines whether the document is an unprocessable document. An unprocessable document refers to an encrypted document or a document archived by using a method which is difficult to interpret. Since neither the document management server 102 nor the PC 101 can generate a preview image or extract a display document from an unprocessable document, the document management server 102 does not need to transmit to the PC 101 the document entity as the preview-image document.

When the document registration processing unit 302 determines that the document is an unprocessable document (YES in step S802), the processing proceeds to step S808. In step S808, the document registration processing unit 302 stores in a preview-image document information storage unit 311 a fixed image document (fixed image) as a preview-image document. The document registration processing unit 302 sets “FIX” as the preview-image document type data, and adds relevant preview-image document information to the preview-image document information storage unit 311. An image with fixed character strings or a plain image is used as a fixed image document, which is predefined in the document management server 102.

When the document registration processing unit 302 determines that the document is not an unprocessable document (NO in step S802), the processing proceeds to step S803. In step S803, the document registration processing unit 302 reads document information and determines whether the document size is equal to or less than a predetermined size. The less the entity document size, the less the load applied to the network 100. Accordingly, the small entity size brings a better overall efficiency than that when preprocessing the document entity on the document management server 102.

When the document registration processing unit 302 determines that the document size is equal to or less than the predetermined size (YES in step S803), the processing proceeds to step S807. The predetermined size used to determine the document size in step S803 is previously defined in the document management server 102. The predetermined size may be fixed for all documents or set differently for each document format.

When the document registration processing unit 302 determines that the document size is larger than the predetermined size (NO in step S803), the processing proceeds to step S804. In step S804, the document registration processing unit 302 determines whether the document management server 102 can generate a preview image of the document.

The determination whether the document management server 102 can generate a preview image may be made based on the throughput of the document management server 102 or by using another program capable of performing the determination processing. In the present exemplary embodiment, descriptions on a program for determining whether the document management server 102 can generate a preview image will be omitted.

When the document registration processing unit 302 determines that the document management server 102 can generate a preview image of the document (YES in step S804), the processing proceeds to step S805. When the document registration processing unit 302 determines that the document management server 102 cannot generate a preview image of the document (NO in step S804), the processing proceeds to step S809.

In step S805, the document registration processing unit 302 determines whether the document is a structured document. The determination whether the document is a structured document is made based on document formats previously defined in the document management server 102. When the document registration processing unit 302 determines that the document is a structured document (YES in step S805), the processing proceeds to step S806.

When the document registration processing unit 302 determines that the document is not a structured document (NO in step S805), the processing proceeds to step S811, and the document registration processing unit 302 leaves processing to the preview-image document generation unit 303.

In step S806, the document registration processing unit 302 determines whether a display document can be extracted from the document. When the document registration processing unit 302 determines that a display document cannot be extracted from the document (NO in step S806), the processing proceeds to step S807.

When the document registration processing unit 302 determines that a display document can be extracted from the document (YES in step S806), the processing proceeds to step S812, and the document registration processing unit 302 leaves processing to the preview-image document generation unit 303. In step S807, the document registration processing unit 302 stores the document entity in the preview-image document information storage unit 311 as a preview-image document. The document registration processing unit 302 sets “ORG” as the preview-image document type data, and adds relevant preview-image document information to the preview-image document information storage unit 311.

In step S809, the document registration processing unit 302 determines whether the document is a dividable document. When the document registration processing unit 302 determines that the document is a dividable document (YES in step S809), the processing proceeds to step S810, and the document registration processing unit 302 leaves processing to the preview-image document generation unit 303.

When the document registration processing unit 302 determines that the document is not a dividable document (NO in step S809), the processing proceeds to step S807. In step S810, the preview-image document generation unit 303 acquires a document divided for a page at a head, and stores the document entity after division in the preview-image document information storage unit 311 as a preview-image document. The preview-image document generation unit 303 sets “TOP” as the preview-image document type data, and adds relevant preview-image document information to the preview-image document information storage unit 311. Although, in the present exemplary embodiment, the document divided for the head is one page, the document may be divided for any number of pages preset in the document management server 102.

In step S811, the preview-image document generation unit 303 converts the starting pages of the document into a low resolution image document (low resolution image), and stores the image document entity after conversion, in the preview-image document information storage unit 311 as a preview-image document. The preview-image document generation unit 303 sets “LOW” as the preview-image document type data, and adds relevant preview-image document information to the preview-image document information storage unit 311.

In step S812, the preview-image document generation unit 303 extracts the display document 708 from the structured document, and stores it in the preview-image document information storage unit 311 as a preview-image document. The preview-image document generation unit 303 sets “DSP” as the preview-image document type data, and adds relevant preview-image document information to the preview-image document information storage unit 311.

Thus, when the document registration processing is performed in the document management server 102, document information as illustrated in FIG. 6A. is stored in the document/folder information storage unit 310. Preview-image document information as illustrated in FIG. 6B is stored in the preview-image document information storage unit 311 based on the document state (preview-image document storage processing). Thus, different preview-image documents are preset in the document management server 102 based on the format, type, and size of the document to be registered.

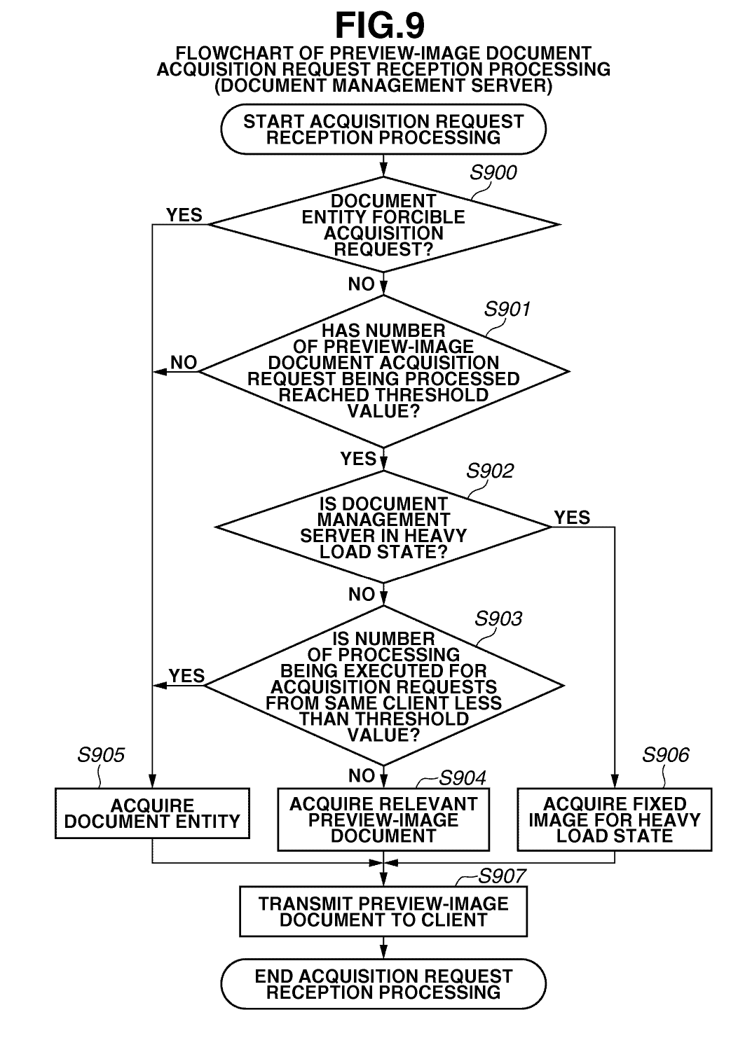

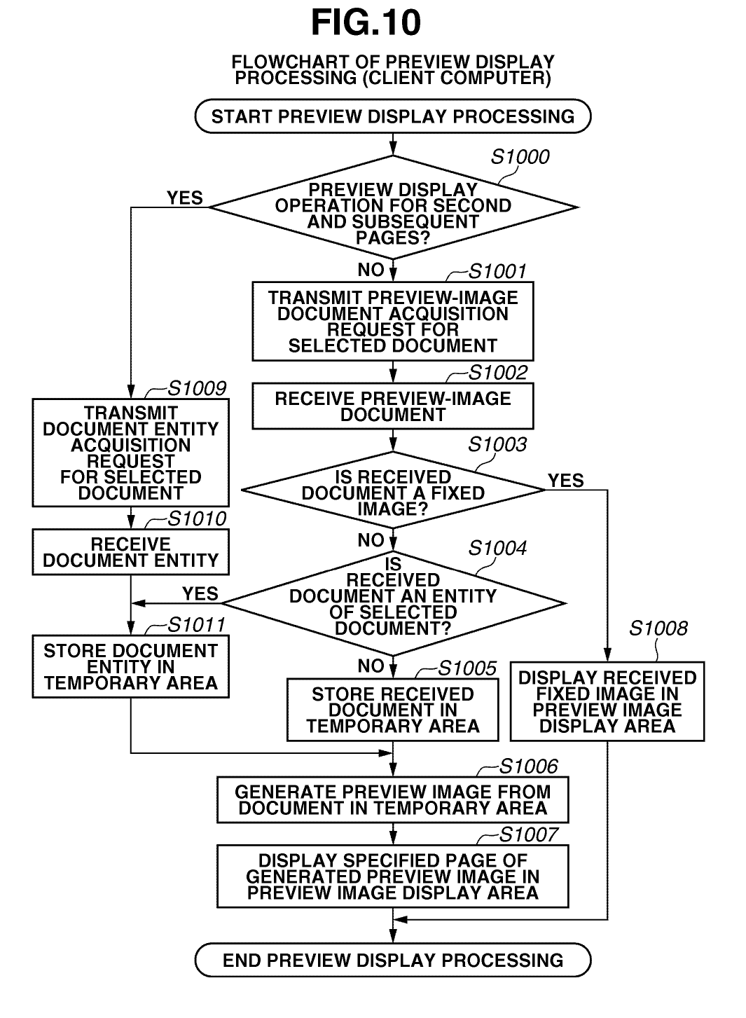

Processing from the time when the PC 101 according to the present exemplary embodiment transmits a preview-image document acquisition request until the time when it receives a preview-image document will be described below with reference to flowcharts in FIGS. 9 and 10. Processing from the time when the document management server 102 receives a preview-image document acquisition request (from the preview-image document acquisition request transmission unit 321 of the PC 101) until the time when it transmits a preview-image document to the PC 101 will be described below with reference to FIG. 9. Processing from the time when the PC 101 transmits a preview-image document acquisition request until the time when it receives a preview-image document will be described below with reference to FIG. 10.

Programs for the PC 101 and the document management server 102 related to the flowcharts and data required to execute the programs are prestored in the HDD 209 of the document management server 102, and loaded into the RAM 202. The programs are executed by the CPU 201. A temporary area of the RAM 202 or HDD 209 is used for data transfer between the steps.

When the user selects any document displayed in the subfolder and document list display area 403 of the document management application on the PC 101, the document management application on the PC 101 transmits a preview-image document acquisition request to the document management server 102. It is premised that, when the user successively operate documents by using the arrow keys on the KB 208 of the PC 101 or through a mouse operation with the KB 208, parallel processing is performed.

When the user performs a document selection operation in the subfolder and document list display area 403 or a preview display operation in the page operation area 407 of the document management application on the PC 101, the processing starts the flowchart in FIG. 10.

In step S1000, the preview-image document acquisition request transmission unit 321 determines whether the user operation is a request for a preview display for the second and subsequent pages or a request for a document selection.

When the preview-image document acquisition request transmission unit 321 determines that the user operation is the request for the preview display for the second and subsequent pages (YES in step S1000), the processing proceeds to step S1009.

Since the preview display operation for the second and subsequent pages means that the user is attempting to refer to the contents of a selected document, the preview-image document acquisition request transmission unit 321 determines that transmitting an entity of the document is more efficient.

When the preview-image document acquisition request transmission unit 321 determines that the user operation is the request for the document selection operation (NO in step S1000), the processing proceeds to step S1001.

In this case, the preview-image document acquisition request transmission unit 321 considers that a document selection operation in the subfolder and document list display area 403 (FIG. 4) does not necessarily mean that the user is attempting to refer to the contents of the selected document. For example, a document selection operation applies to a case where the user performs successive mouse operations or arrow key operations.

In step S1009, the preview-image document acquisition request transmission unit 321 transmits to the document management server 102 an acquisition request for a document entity of the selected document.

This request includes a flag indicating forcible document entity acquisition regardless of the preview-image document type of the document registered in the document management server 102.

In step S1001, the preview-image document acquisition request transmission unit 321 transmits to the document management server 102 a preview-image document acquisition request for the selected document.

Processing performed by the document management server 102 (FIG. 9) upon reception of a preview-image document acquisition request will be described below.

In step S900, the preview-image document acquisition request receiving unit 304 receives the preview-image document acquisition request from the PC 101.

In step S900, the preview-image document acquisition request receiving unit 304 determines whether the preview-image document acquisition request includes the flag indicating the forcible document entity acquisition.

When the preview-image document acquisition request receiving unit 304 determines that the preview-image document acquisition request includes the flag indicating the forcible document entity acquisition (YES in step S900), the processing proceeds to step S905.

When the preview-image document acquisition request receiving unit 304 determines that the preview-image document acquisition request does not include the flag indicating the forcible document entity acquisition (NO in step S900), the processing proceeds to step S901.

In step S901, the preview-image document acquisition request receiving unit 304 determines whether the number of pieces of processing concurrently being executed for preview-image document acquisition requests on the document management server 102 reaches a predetermined upper-limit value. The upper-limit value of the number of pieces of processing that can be concurrently executed is preset in the document management server 102.

When the preview-image document acquisition request receiving unit 304 determines that the number of pieces of processing concurrently being executed for preview-image document acquisition requests is less than the predetermined upper-limit value (NO in step S901), the processing proceeds to step S905. When the number of pieces of processing concurrently being executed for the user operation is less than the predetermined upper-limit value, the preview-image document acquisition request receiving unit 304 determines that transmitting the document entity does not place much burden on the document management server 102.

When the preview-image document acquisition request receiving unit 304 determines that the number of pieces of processing concurrently being executed for preview-image document acquisition requests has reached the predetermined upper-limit value (YES in step S901), the processing proceeds to step S902.

In step S902, the preview-image document acquisition request receiving unit 304 determines whether the entire document management server 102 is in a heavy-loaded state. The determination of the heavy-loaded state is made based on the CPU usage rate, the amount of memory used, and the number of pieces of processing being concurrently executed in an identical server. Respective threshold values are predefined in the document management server 102.

The heavy-loaded state may be determined either when all of the CPU usage rate, the amount of memory used, and the number of pieces of processing being concurrently executed exceed respective threshold values, or when any one of them exceeds a respective threshold value.

When the preview-image document acquisition request receiving unit 304 determines that the document management server 102 is in the heavy-loaded state (YES in step S902), the processing proceeds to step S906.

When the preview-image document acquisition request receiving unit 304 determines that the document management server 102 is not in the heavy-loaded state (NO in step S902), the processing proceeds to step S903.

In step S903, the preview-image document acquisition request receiving unit 304 determines whether a plurality of acquisition requests from an identical PC is being concurrently executed, and whether the number of pieces of processing being concurrently executed for acquisition requests has reached the predetermined upper-limit value. The upper-limit value of the number of pieces of processing being concurrently executed on an identical PC is preset in the document management server 102.

When the preview-image document acquisition request receiving unit 304 determines that the number of pieces of processing being concurrently executed for acquisition requests from an identical PC is less than the predetermined upper-limit value (YES in step S903), the processing proceeds to step S905.

When the preview-image document acquisition request receiving unit 304 determines that the number of pieces of processing being concurrently executed for acquisition requests from an identical PC has reached the predetermined upper-limit value (NO in step S903), the processing proceeds to step S904.

The preview-image document acquisition request receiving unit 304 leaves processing to a preview-image document acquisition processing unit 305.

In step S904, the preview-image document acquisition processing unit 305 acquires a document-related preview-image document entity from the preview-image document information storage unit 311, and the processing proceeds to step S907.

In step S905, the preview-image document acquisition processing unit 305 acquires the document entity from the document/folder information storage unit 310, and the processing proceeds to step S907.

In step S906, the preview-image document acquisition processing unit 305 acquires a fixed image document indicating a heavy-loaded state of the document management server 102 from the document/folder information storage unit 310, and the processing proceeds to step S907. An image having a character string indicating a heavy-loaded state of the document management server 102 is used as a fixed image document. The fixed image document is prestored in the document/folder information storage unit 310 of the document management server 102.

In step S907, the document data transmission unit 306 transmits to the PC 101 the document entity or the preview-image document entity acquired from the document/folder information storage unit 310 or the preview-image document information storage unit 311. At the time of transmission, the document data transmission unit 306 also transmits the document type and other pieces of document information together with the document entity.

Processing performed by the PC 101 in FIG. 10 after reception of the preview-image document will be described below.

In step S1002, the preview-image document acquisition request transmission unit 321 receives the preview-image document from the document management server 102, and the processing proceeds to step S1003.

In step S1010, the preview-image document acquisition request transmission unit 321 receives the document entity from the document management server 102, and the processing proceeds to step S1011.

In step S1003, the preview-image document acquisition request transmission unit 321 determines whether the type of the received preview-image document is a fixed image document. The document type is included, together with the received document data, in the document information received from the document management server 102.

When the preview-image document acquisition request transmission unit 321 determines that the type of the received preview-image document is a fixed image document (YES in step S1003), the processing proceeds to step S1008.

When the preview-image document acquisition request transmission unit 321 determines that the type of the received preview-image document is not a fixed image document (NO in step S1003), the processing proceeds to step S1004.

In step S1004, the preview-image document acquisition request transmission unit 321 determines whether the type of the received preview-image document is an entity of the selected document.

When the preview-image document acquisition request transmission unit 321 determines that the type of the received preview-image document is the entity of the selected document (YES in step S1004), the processing proceeds to step S1011.

When the preview-image document acquisition request transmission unit 321 determines that the type of the received preview-image document is not the entity of the selected document (NO in step S1004), the processing proceeds to step S1005.

In steps S1005 and S1011, the preview-image document acquisition request transmission unit 321 stores the document entity and the preview-image document entity, in the temporary area of the document information storage unit 330 of the PC 101.

In step S1006, the preview image generation unit 322 reads the document entity or the preview-image document entity from the temporary area of the document information storage unit 330, generates a preview image, and stores it in the document information storage unit 330. The preview image generation unit 322 determines a page to be generated depending on preview display processing of the selected document or preview display processing in a page operation.

Preview image generation processing is not directly related to the present invention, and descriptions will be omitted.

In step S1007, the preview image display processing unit 323 reads the generated preview image from the document information storage unit 330, and displays it in the preview image display area 406.

In step S1008, the preview image display processing unit 323 displays the received fixed image document in the preview image display area 406 as a preview image.

As described above, when the document management server 102 performs processing for a preview-image document acquisition request, the document management server 102 transmits a suitable preview-image document to the PC 101 based on the data items in FIGS. 6A and 6B. Further, depending on the load state of the document management server 102 or the number of processing being concurrently executed for acquisition requests from an identical PC, the document management server 102 suitably transmits to the PC 101 any one of a fixed image, an original document, a divided document, a display document, and a low-resolution document converted into an image, as the situation demands.

The document entity and the preview-image document are used differently depending also on a user operation on the document management application of the PC 101, enabling flexible preview image display processing. In the present exemplary embodiment described above, the document registration processing determines a preview-image document type (any one of a document entity, a low-resolution image document, a document divided for a predetermined number of starting pages, and a fixed image document) of the document, and registers this information in association with the document.

When displaying the preview image of the document on the PC 101, the PC 101 distinguishes whether the preview-image document is to be acquired or the document entity is forcibly acquired, depending on a user operation, and transmits a document acquisition request to the document management server 102.

Upon completion of the processing for a preview-image document acquisition request, the document management server 102 transmits a most suitable document based on the number of pieces of processing concurrently being executed, the number of pieces of processing being concurrently executed for requests from an identical client, a load state of the server, and the preview-image document set at the time of document registration.

By performing preview-image document management in this way at the time of document registration and at the time of acquisition request, the documents can be efficiently processed and the overall load on the document management server 102, the PC 101, and the network 100 is reduced.

### Other Embodiments

Aspects of the present invention can also be realized by a computer of a system or apparatus (or devices such as a CPU or MPU) that reads out and executes a program recorded on a memory device to perform the functions of the above-described embodiment (s), and by a method, the steps of which are performed by a computer of a system or apparatus by, for example, reading out and executing a program recorded on a memory device to perform the functions of the above-described embodiment (s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2011-036023 filed Feb. 22, 2011, which is hereby incorporated by reference herein in its entirety.

What is claimed is:

1. A document management apparatus connectable with an information processing apparatus configured to transmit a document registration request and an acquisition request for a document, the document management apparatus comprising:
a document entity storage unit configured to, in response to a document registration request from the information processing apparatus, store a document entity of the document;
an acquisition unit configured to acquire document information of the document;
a preview-image document storage unit configured to store data of a type determined based on the document information acquired by the acquisition unit, as a preview-image document of the document; and
a transmission unit configured to, upon reception of an acquisition request for the preview-image document from the information processing apparatus, determine whether the preview-image document stored in the preview-image document storage unit or the document entity stored in the document entity storage unit is to be transmitted based on a state of the document management apparatus, and transmit data determined to be transmitted.

2. The document management apparatus according to claim 1, wherein, when the document can be processed neither by the document management apparatus nor by the information processing apparatus, the preview-image document storage unit stores as the preview-image document a fixed image predefined in the document management apparatus.

3. The document management apparatus according to claim 1, wherein, when a size of the document is less than a predetermined value, the preview-image document storage unit stores a document entity of the document as the preview-image document.

4. The document management apparatus according to claim 1, wherein, when the document is a structured document and when a display document can be extracted from the structured document, the preview-image document storage unit stores the display document as the preview-image document.

5. The document management apparatus according to claim 1, wherein, when a size of the document is larger than a predetermined size and when the document management apparatus can generate an image having a lower resolution than a document entity of the document, the preview-image document storage unit stores a low-resolution image of a starting page of the document as a preview-image document.

6. The document management apparatus according to claim 1, wherein, when a size of the document is larger than a predetermined size, when the document management apparatus can generate an image having a lower resolution than a document entity of the document, and when the document is a dividable document, the preview-image document storage unit stores a divided document in one starting page of the document as a preview-image document.

7. The document management apparatus according to claim 1, wherein, when the document acquisition request is an acquisition request for the preview-image document and when the number of pieces of processing being currently executed for the preview-image document acquisition requests does not reach a threshold value, the transmission unit transmits the document entity to the information processing apparatus.

8. The document management apparatus according to claim 1, wherein, when the document acquisition request is an acquisition request for the preview-image document and when the document management apparatus is in a heavy-loaded state, the transmission unit transmits to the information processing apparatus an image indicating the heavy-loaded state of the document management apparatus, prestored in the document management apparatus.

9. The document management apparatus according to claim 1, wherein, when the document acquisition request is an acquisition request for the preview-image document and when among processing being currently executed for preview-image document acquisition requests by the document management apparatus, a number of processing for acquisition requests from an identical information processing apparatus does not reach a threshold value, the transmission unit transmits the document entity to the information processing apparatus.

10. A method for controlling a document management apparatus connectable with an information processing apparatus configured to transmit a document registration request and an acquisition request for a document, the method comprising:
storing, in response to a document registration request from the information processing apparatus, a document entity of the document;
acquiring document information of the document;
storing data of a type determined based on the acquired document information, as a preview-image document of the document; and
determining, upon reception of an acquisition request for the preview-image document from the information processing apparatus, whether the preview-image document or the document entity is to be transmitted based on a state of the document management apparatus, and transmitting data determined to be transmitted.

11. A computer-readable storage medium storing a computer-executable process, the computer-executable process causing a processor of a document management apparatus to execute a method comprising:
storing, in response to a document registration request from the information processing apparatus, a document entity of the document;
acquiring document information of the document;
storing data of a type determined based on the acquired document information, as a preview-image document of the document; and
determining, upon reception of an acquisition request for the preview-image document from the information processing apparatus, whether the preview-image document or the document entity is to be transmitted based on a state of the document management apparatus, and transmitting data determined to be transmitted.
